(19) United States
(12) Patent Application Publication
(10) Pub. No.: US 2005/0108649 A1
(43) Pub. Date: May 19, 2005

(54) Control apparatus, control instruction apparatus, control program product and control instruction program product for transmitting/receiving data described in extensible markup language

(75) Inventor: Takashi Ueda, Kashiba-shi (JP)

Correspondence Address: BURNS DOANE SWECKER & MATHIS L L P, POST OFFICE BOX 1404, ALEXANDRIA, VA, 22313-1404, US

(73) Assignee: Konica Minolta Business Technologies, Inc.

(21) Appl. No.: 10/759,141

(22) Filed: Jan. 20, 2004

(30) Foreign Application Priority Data
Oct. 15, 2003 (JP) 2003-355129(P)

(51) Int. Cl. G06F 3/00; G06F 9/00; G06F 17/00; G06F 15/16

(52) U.S. Cl. 715/760; 709/203

(57) ABSTRACT

In order to improve throughput while transmitting/receiving data described in a standard language, a control apparatus includes: an XML data input/output interface to receive command data described in an extensible markup language (XML); an XML data analyzer to analyze the command data; and an MFP controller, when an element in which a control code is defined in a tag is detected from the command data by the XML data analyzer, to execute a process which is preliminarily associated with the control code defined in the tag of the element.

This application is based on Japanese Patent Application No. 2003-355129 filed with Japan Patent Office on Oct. 15, 2003, the entire content of which is hereby incorporated by reference.

### BACKGROUND OF THE INVENTION

1. Field of the Invention

The present invention relates to a control apparatus, a control instruction apparatus, a control program product and a control instruction program product and, more particularly, to a control apparatus, a control instruction apparatus, a control program product and a control instruction program product for transmitting/receiving data described in the extensible markup language.

2. Description of the Related Art

In recent years, a technique of connecting two apparatuses to each other via a network and controlling one of the apparatuses by the other apparatus is employed. As communication data transmitted/received between apparatuses, data described in a standardized language typified by the extensible markup language (hereinafter, referred to as “XML”) is used. By using the standardized language, an existing program can be used as a program for transmitting/receiving communication data and efficiency of developing an application program can be improved.

Japanese Laid-Open Patent Publication No. 2003-23620 discloses a captured image transmitting apparatus including: an image capturing camera; and a camera server to transmit an image captured by the image capturing camera via a predetermined communication path to a receiving station disposed in a remote place from the image capturing camera, wherein the camera server holds a control program to control the image capturing camera by a command operation in the receiving station, and the command operation is defined in the extensible markup language by the control program.

Japanese Laid-Open Patent Publication No. 2002-369969 discloses a program to play a game between two kinds of game terminals via a communication medium. The program makes a computer to control game terminals execute: a process to convert data describing an option selected by the user of the game terminal from a group of options allowed by a game rule into data into an XML format; a process to transmit the option describing data converted into the XML format to the other game terminal; and a process to convert option describing data transmitted in the XML format from the other game terminal into data in a format which can be processed by the game terminal itself.

Although the extensible markup language is a general language, it has demerits that the language is redundant and a large data amount is resulted. It causes a problem in that an amount of data transmitted/received is large, a data amount which can be transmitted/received per unit time decreases, and throughput deteriorates.

### SUMMARY OF THE INVENTION

The present invention has been made to solve the above problem and an object of the present invention is to provide a control apparatus and a control instruction apparatus with improved throughput while transmitting/receiving data described in a standard language.

Another object of the present invention is to provide a control program product and a control instruction program product with improved throughput while transmitting/receiving data described in a standard language.

According to an aspect of the present invention, in order to achieve the above objects, a control apparatus includes: a receiver to receive command data described in an extensible markup language; an analyzer to analyze the command data; and a controller, when an element in which a control code is defined in a tag is detected from the command data by the analyzer, to execute a process which is preliminarily associated with the control code defined in the tag of the element.

According to the present invention, when command data described in the extensible markup language is analyzed and an element in which a control code is defined in a tag is detected from the command data, a process which is preliminarily associated with the control code defined in the tag of the element is executed. Since the control code is described in the extensible markup language, a rule such as a special communication procedure is unnecessary between the apparatus and the transmission source of the command data. Since the control code is defined in the tag, the configuration of the extensible markup language is simplified, and the data amount of the command data can be decreased. As a result, it is possible to provide a control apparatus with improved throughput while transmitting/receiving data described in a standard language.

According to another aspect of the present invention, a control instruction apparatus includes: a display portion to display an input screen for inputting a control code; a command data generator to generate command data described in an extensible markup language, including an element in which a control code to specify a process for executing a control is defined in a tag in accordance with data inputted via the input screen; and a command data transmitter to transmit the generated command data.

According to the present invention, command data described in an extensible markup language, including an element in which a control code to specify a process for executing a control is defined in a tag is generated and transmitted. Since the command data is described in the extensible markup language, a rule such as a special communication procedure is unnecessary between the apparatus and the transmission source of the command data. Since the control code is defined in the tag, the configuration of the extensible markup language is simplified, and the data amount of the command data can be decreased. As a result, it is possible to provide a control instruction apparatus with improved throughput while transmitting/receiving data described in a standard language.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing an outline of a whole print system in one of embodiments of the present invention.

FIG. 2 is a functional block diagram showing an outline of the function of an MFP in the embodiment.

FIGS. 3A and 3B are diagrams showing an example of command data used in the print system in the embodiment in comparison with conventional command data.

FIGS. 4A to 4C are diagrams showing an example of response data used in the print system in the embodiment in comparison with conventional response data.

FIG. 5 is a flowchart showing the flow of processes executed by the MFP in the embodiment.

FIG. 6 is a flowchart showing the flow of processes executed, by a computer for user in the embodiment.

FIG. 7 is a diagram showing an example of a menu screen displayed on the computer for user.

FIG. 8 is a diagram showing an example of a job execution screen displayed on the computer for user.

FIGS. 9A and 9B are diagrams showing an example of command data generated when an instruction button is instructed in the job execution screen and an example of response data corresponding to the command data.

FIG. 10 is a diagram showing an example of a file transmission screen displayed on the computer for user.

FIGS. 11A and 11B are diagrams showing an example of command data generated when a transmission button is instructed in the file transmission screen and an example of response data corresponding to the command data.

FIG. 12 is a diagram showing an example of a print execution screen displayed on the computer for user.

FIGS. 13A and 13B are diagrams showing an example of command data generated when a print button is instructed in the print execution screen and an example of response data corresponding to the command data.

### DESCRIPTION OF THE PREFERRED EMBODIMENTS

Hereinafter, embodiments of the present invention will be described with reference to the drawings. In the following description, the same reference numeral is given to the same parts. The names and the functions of the parts are the same. Therefore, their detailed description will not be repeated.

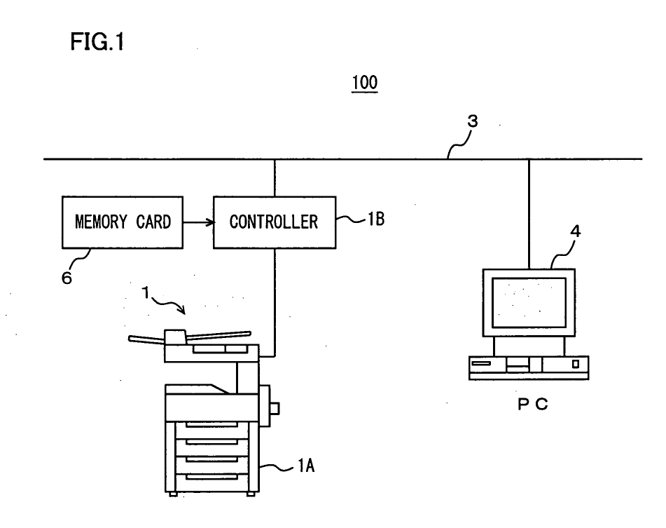

FIG. 1 is a diagram showing an outline of a whole print system in one of the embodiments of the present invention. Referring to FIG. 1, a print system 100 includes a multi function peripheral 1 (hereinafter, referred to as “MFP 1”) and a computer 4 for user, which are connected to a network 3. Computer 4 for user is a general personal computer. In the figure, an example of connecting one MFP 1 and one computer 4 for user will be described. It is also possible to connect a plurality of MFPs and a plurality of computers for user to network 3.

MFP (Multi Function Peripheral) 1 includes an MFP main body 1A and a controller 1B for connecting MFP main body 1A to network 3. MFP main body 1A includes a scanner for reading an original, an image forming device for forming an image onto a recording medium such as a sheet of paper on the basis of image data, and a facsimile, and has an image reading function, a copying function, a facsimile transmitting/receiving function and a printing function of printing data. MFP 1 forms an image onto a recording medium such as a sheet of paper by an image forming device on the basis of print data received from computer 4 for user or image data outputted from the scanner.

Controller 1B is connected to computer 4 for user via network 3. Controller 1B functions as a Web server and stores a Web page in a memory device such as a read only memory (ROM) thereof.

Computer 4 for user executes a browser program therein. When the browser program is executed in computer 4 for user and a Web page of controller 1B functioning as a Web server is accessed, the Web page is transmitted to computer 4 for user. The Web page includes a program for displaying a screen for inputting a control code, a program for generating command data described in the XML which defines a control code in a tag in accordance with an instruction of the user, and a program for transmitting the generated command data to controller 1B.

Therefore, on the display of computer 4 for user, the Web page transmitted from controller 1B is displayed. Only by selecting a predetermined control for controlling the whole MFP 1A body by the user, command data in which a control code corresponding to the selected control is defined in a tag is generated, and transmitted to controller 1B. Controller 1B analyzes the received command data, extracts the control code, and controls MFP main body 1A so that the control corresponding to the control code is executed by MFP main body 1A. In such a manner, MFP main body 1A can be controlled by computer 4 for user.

In controller 1B, a portable, removable memory card 6 is inserted. An information processing program stored in memory card 6 is executed by a central processing unit (CPU) of controller 1B. Since data stored in memory card 6 can be rewritten or data can be added to memory card 6, another computer connected to network 3 may rewrite the information processing program stored in memory card 6 or add a new information processing program. Further, controller 1B may download an information processing program from another computer connected to network 3 and store the information processing program to memory card 6.

Network 3 is a local area network (LAN), the Internet, a general public line or the like, and may be wired or wireless. Although an example in which MFP 1 and computer 4 for user are connected via network 3 will be described here, MFP 1 and computer 4 for user may be connected to each other by using a serial line or a parallel line.

Although the example in which the information processing program to be executed by controller 1B is stored in memory card 6 and distributed has been described, another medium for carrying a program in a fixed manner may be also used, such as a flexible disk, a cassette tape, a CD-ROM, a hard disk, an optical disk (MO (Magnetic Optical Disc), MD (Mini Disc), and DVD (Digital Versatile Disc), an IC card (including a memory card), an optical card, or a semiconductor memory such as a mask ROM, an EPROM (Erasable, Programmable Read-Only Memory), or an EEPROM (Electrically Erasable/Programmable Read Only Memory).

The program is not limited to a program which can be executed directly by the CPU but also includes a program in a source program form, a compressed program and an encrypted program.

In the embodiment, MFP main body 1A and controller 1B are described as separate members. Alternately, controller 1B may be provided in MFP main body 1A.

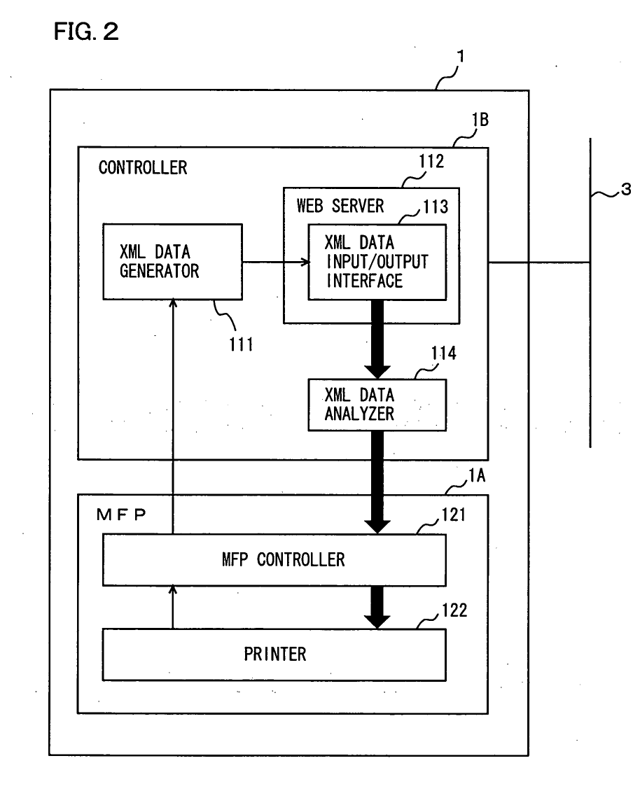

FIG. 2 is a functional block diagram showing an outline of functions of the MFP in the embodiment. Referring to the figure, MFP 1 includes MFP main body 1A and controller 1B. Controller 1B includes: a Web server 112 for executing the function of the Web server; an XML data analyzer 114 for analyzing XML data received by Web server 112; and an XML data generator 111 for generating XML data and outputting the XML data to Web server 112. Web server 112 includes an XML data input/output interface 113 for controlling input/output of XML data.

MFP main body 1A includes an MFP controller 121 for controlling whole MFP main body 1A and a printer 122 for forming an image on a recording medium such as a sheet of paper.

Web server 112 makes controller 1B function as a Web server. For this purpose, Web server 112 has a read only memory (ROM) for storing a Web page. Web server 112 is physically connected to network 3 and logically connects controller 1B to computer 4 for user so as to enable communication. Web server 112 includes XML data input/output interface 113 and controls communication between controller 1B and computer 4 for user. In communication between controller 1B and computer 4 for user, data described in the hyper text markup language (HTML) or XML is transmitted/received.

When a browser program is executed in computer 4 for user, a Web page stored in Web server 112 is accessed by the browser. Web server 112 transmits the accessed Web page to computer 4 for user. This Web page includes a program for displaying a screen for inputting a control code, a program for generating command data described in the extensible markup language, in which a control code is defined in a tag in accordance with an instruction of the user, and a program for transmitting the generated command data to controller 1B.

When command data is received from computer 4 for user, XML data input/output interface 113 outputs the received command data to XML data analyzer 114. Web server 112 transmits XML data generated by XML data generator 11 which will be described later to computer 4 for user via network 3.

XML data analyzer 114 includes an XML parser (also referred to as an XML processor). XML data analyzer 114 checks syntax of the XML data which is inputted from XML data input/output interface 113 and verifies the data structure. XML data analyzer 114 develops the XML data to a tree structure.

In the embodiment, the command data is received by XML data input/output interface 113 from computer 4 for user. The command data is XML data described in the XML. XML data analyzer 114 extracts the control code from the command data developed to the tree structure and outputs the control code to MFP controller 121 of MFP main body 1A.

XML data generator 111 receives a result of execution of the process from MFP controller 121 of MFP main body 1A. The execution result is a result achieved by executing a process corresponding to the control code outputted from XML data analyzer 114. The execution result is, concretely, information indicating whether the process corresponding to the control code has been normally executed or not. XML data generator 111 generates response data in which the control code extracted by XML data analyzer 114 and the execution result are associated with each other, and outputs the response data to XML data input/output interface 113. The response data generated here is data described in the XML and including an element in which the control code is defined in the tag and the execution result is data. By the element in which the control code is defined in the tag and the execution result is data, the control code and the execution result are associated with each other.

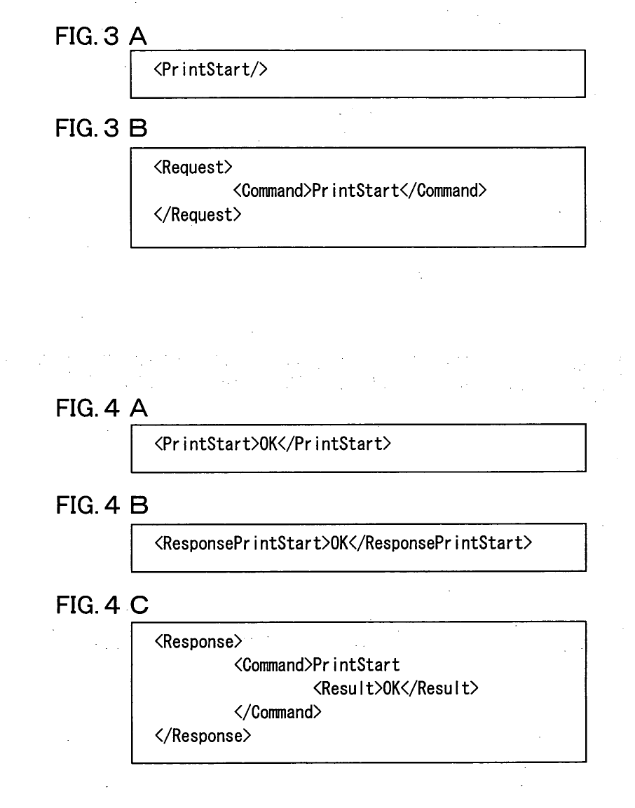

FIG. 3A is a diagram showing an example of command data used in print system 100 in the embodiment. Referring to FIG. 3A, in the command data, a control code “PrintStart” for instructing execution of printing by MFP 1 is defined in the tag.

FIG. 3B is a diagram showing conventional XML data describing the control code in the XML. Referring to FIG. 3B, the conventional XML data includes an element indicative of request for execution of the control code and, at a lower order of the element, an element including the control code as data. Concretely, in the higher-order element, “Request” indicative of request for execution of the control code is defined in the tag. In the lower-order element, “Command” is defined in the tag and “PrintStart” is data. Consequently, the data is described in three lines.

As described above, the command data in the embodiment is described in one line since the control code itself is defined in the tag. Moreover, the element does not include data, so that the element can be described by only a tag in which a start tag and an end tag are combined. Consequently, as compared with an element including data, the command data is shorter description.

FIG. 4A shows an example of response data used in the print system in the embodiment. Referring to FIG. 4A, in the response data, an execution result “OK” to be responded is set as data, and the control code “PrintStart” corresponding to the execution result is defined in the tag.

FIG. 4B is a diagram showing another example of response data used in the print system in the embodiment. Referring to FIG. 4B, in response data, an execution result “OK” to be responded is data, and a code “ResponsePrintStart” as a result of executing a process corresponding to the control code “PrintStart” is defined in the tag.

In this case as well, the response data is described in one line.

FIG. 4C is a diagram showing conventional XML data of an execution result described in the XML. Referring to FIG. 4C, the conventional XML data includes an element indicative of an execution result, a lower-order element of specifying a control code corresponding to an executed process, and a further-lower-order element including the execution result as data. Concretely, the conventional XML data includes: as a high-order element, an element having a tag of “Response” indicative of a response; as a lower-order element, an element in which “Command” indicative of a control code corresponding to the process executed on the data is defined in the tag; and as a further-lower-order element, an element in which “Result” indicating that the data is the execution result is defined in the tag. Consequently, the conventional XML data is described in five lines.

As described above, the response data in the embodiment is described in one line since the control code itself or the code indicative of a response to the control code is defined in the tag. Thus, the data amount can be reduced.

In the embodiment, the control code is defined in the tag by the command data and the response data. The command data is transmitted only from computer 4 for user to MFP 1 and is not transmitted from MFP 1 to computer 4 for user. The response data is transmitted only from MFP 1 to computer 4 for user and is not transmitted from computer 4 for user to MFP 1. Therefore, even when the same control code is defined in the tag, MFP 1 determines that the tag indicates the control code, and computer 4 for user determines that the tag is a tag including an execution result as data.

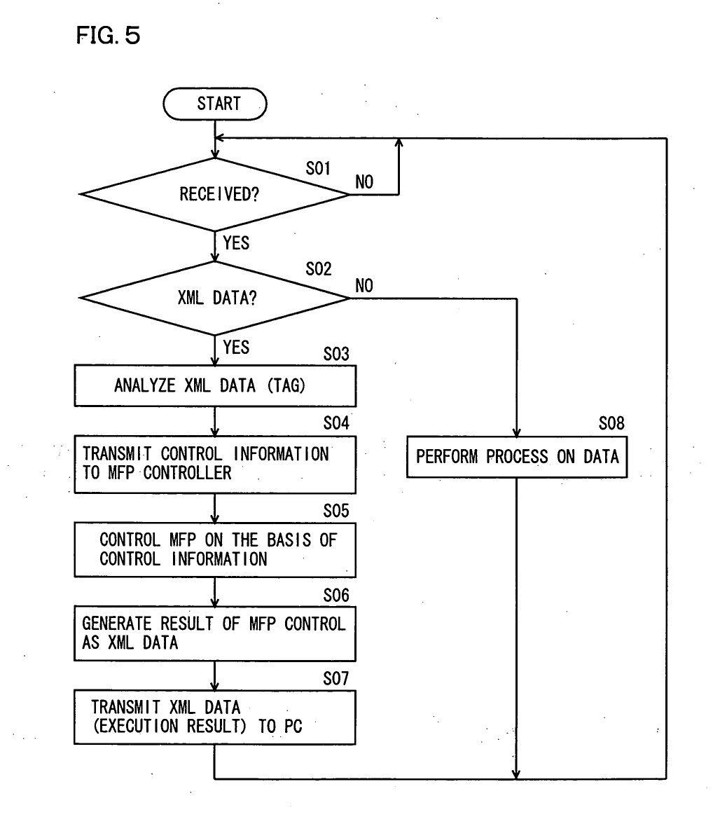

FIG. 5 is a flowchart showing the flow of processes executed by the MFP in the embodiment. Referring to FIG. 5, in MFP 1, whether data is received by Web server 112 or not is detected (step S01). In the case where data is received, an interruption is generated and the program proceeds to step S02.

In step S02, whether the received data is XML data or not is determined. In the case where the received data is determined as XML data, the program proceeds to step S03. If not, the program proceeds to step S08. By the process, XML data received by Web server 112 is transmitted to AL data analyzer 114.

In step S03, in XML data analyzer 114, the XML data is analyzed. Specifically, the syntax of the XML data is checked, the data structure is verified, and the XML data is developed to a tree structure. In the embodiment, in XML data input/output interface 113, the XML data received from computer 4 for user is command data. The command data is developed to a tree structure. For example, in the case where the command data shown in FIG. 3A is received, the tag “PrintStart” having no data is obtained. Then the control information is transmitted to MFP controller 121 (step S04). The control information includes the control code defined in the tag of the command data.

MFP controller 121 controls printer 122 so that a process is executed in accordance with the received control code (step S05). In MFP 1 in the embodiment, a program having the same name as the control code is pre-stored in a read only memory (ROM) of MFP controller 121. When the control code is received, MFP controller 121 reads the program of the same name as that of the control code and executes the program. In such a manner, the process corresponding to the control code is executed.

MFP controller 121 detects a result of the process executed by printer 122 and outputs the result of the process (execution result) to XML data generator 111. The execution result is information indicating whether the process has been executed normally or not. XML data generator 111 generates response data described in the XML, including an element in which the received execution result is data and the control code “PrintStart” obtained in step S03 is defined in the tag (step S06). When the generated response data is outputted to XML data input/output interface 113, XML data input/output interface 113 transmits the inputted response data to computer 4 for user (step S07). The computer for user receives the result of the process executed by MFP 1 (execution result).

On the other hand, in the case where it is determined that the data is not XML data in step S02, in step S08, the data is processed. For example, in the case where print data is received, a process of transmitting the received print data to MFP controller 121 is performed.

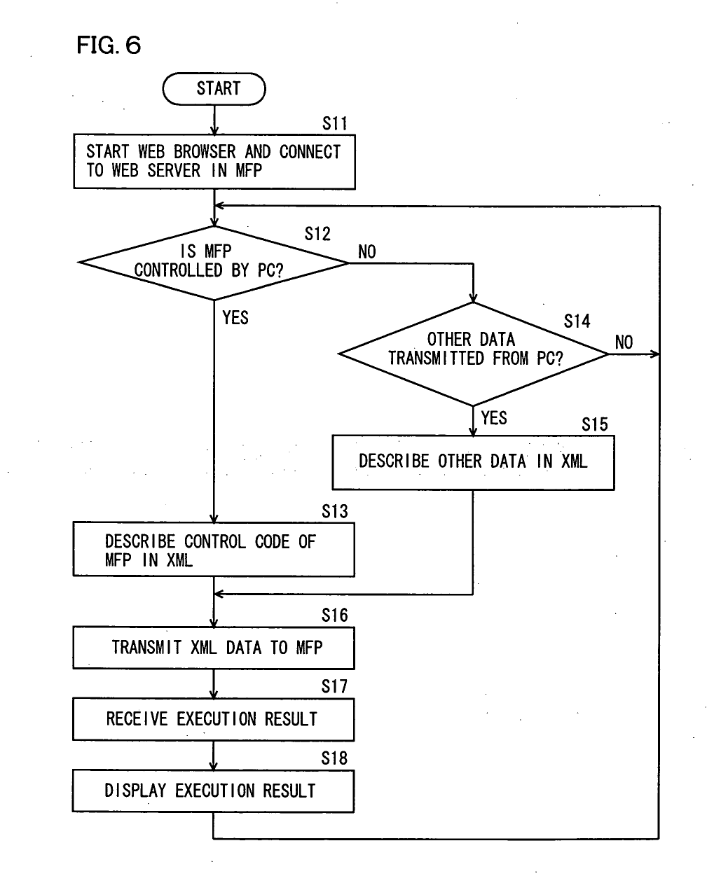

FIG. 6 is a flowchart showing the flow of processes executed by the computer for user in the embodiment. Referring to FIG. 6, first, computer 4 for user executes a browser program to start a Web browser. The Web browser is connected to Web server 112 built in controller 1B of MFP 1 (step S11). The connection is made by, for example, designating a URL (Uniform Resource Locator) prestored in the ROM-of Web server 112. By the above, a Web page is displayed on the display of computer 4 for user.

Whether MFP 1 is controlled by computer 4 for user or not is determined (step S12). The determination is made according to whether the user enters an instruction for inputting the control code from the screen displayed on the display or not. In the case where the instruction is entered, the program proceeds to step S13. If the instruction is not entered, the program proceeds to step S14.

In step S 13, command data described in the XML, including an element in which a control code corresponding to the inputted instruction is defined in a tag is generated. A program for generating the command data is included in the Web page received in step S11, and the program is executed by computer 4 for user. Consequently, it is unnecessary to prestore a program and a control code for generating the command data in computer 4 for user.

The generated command data is transmitted to MFP 1 (step S16). The transmission program is also included in the Web page received in step S11 and is executed by computer 4 for user. It is therefore unnecessary to prestore a program for transmitting command data and a network address of a destination in computer 4 for user.

In step S17, the execution result of the process according to the control code included in the command data is received as response data by MFP 1. The response data is data described in the XML as mentioned above. The XML parser program is executed by computer 4 for user, the response data is analyzed, and the execution result is obtained. The XML parser program is usually included in the browser program.

The received execution result is displayed on the display of computer 4 for user (step S18). By the display, the user can recognize the result of execution of the process in response to the instruction immediately after the instruction for executing the process is inputted to MFP 1.

On the other hand, in the case where it is determined in step S12 that MFP 1 is not controlled, in step S14, whether other data is transmitted from computer 4 for user or not is determined. The other data is, for example, print data. In step S15, the other data, for example, print data is described in the XML. In step S16, the print data described in the XML is transmitted to the MFP. In step S15, it is not always necessary to describe the other data in the XML but the other data may be transmitted as it is to MFP 1.

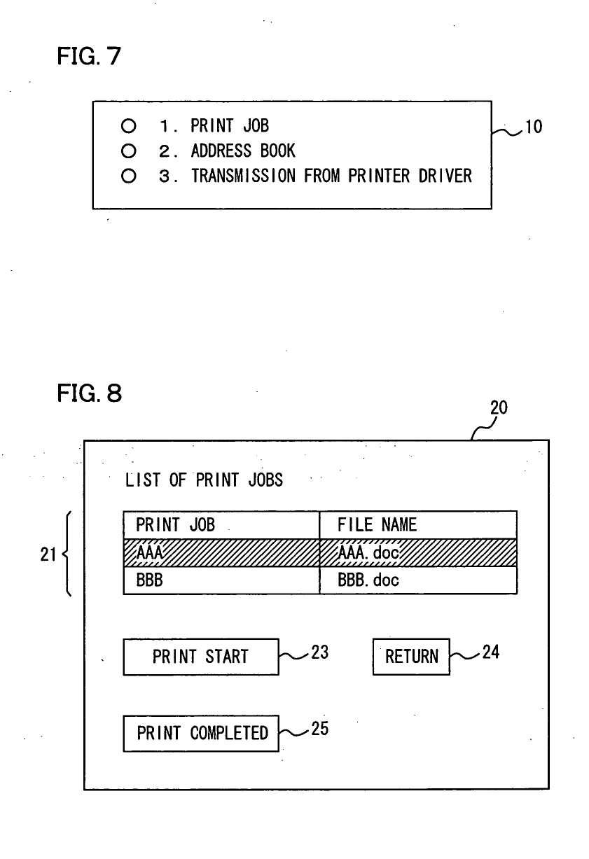

FIG. 7 is a diagram showing an example of a menu screen displayed by the computer for user. The screen is a screen displayed when a program included in the Web page transmitted from the MFP is executed. Referring to FIG. 7, a menu screen 10 includes “1. print job”, “2. address book” and “3. transmission from printer driver”. When “1. print job” is selected, a job execution screen for inputting an instruction for designating a print job to make MFP 1 to execute a printing process is displayed. When “2. address book” is selected, a file transmission screen for inputting an instruction for designating an e-mail address and a transmission file and transmitting the transmission file by an e-mail is displayed. When “3. transmission from printer driver” is selected, the printer driver is started, and a print execution screen for inputting an instruction of making MFP 1 execute the printing process under printing conditions entered on the screen for inputting printing conditions.

FIG. 8 is a diagram showing an example of the job execution screen displayed by the computer for user. Referring to FIG. 8, a job execution screen 20 includes an area 21 for displaying a list of print jobs, an instruction button 23 in which a character. train of “print start” is displayed, a cancel button 24 in which a character train of “return” is displayed, and an execution result display area 25 for displaying an execution result.

In the area 21, a list of job data stored in MFP 1 is displayed. The job data displayed includes the name of a print job, and the name of a file to be printed by the print job. When the user selects desired data from the job data and instructs the instruction button 23, command data is generated and is transmitted to MFP 1. In the diagram, a print job of which name is “AAA” being selected is hatched. Execution result display area 25 is an area for displaying a result of execution of the process by the MFP. When cancel button 24 is instructed, menu screen 10 is displayed.

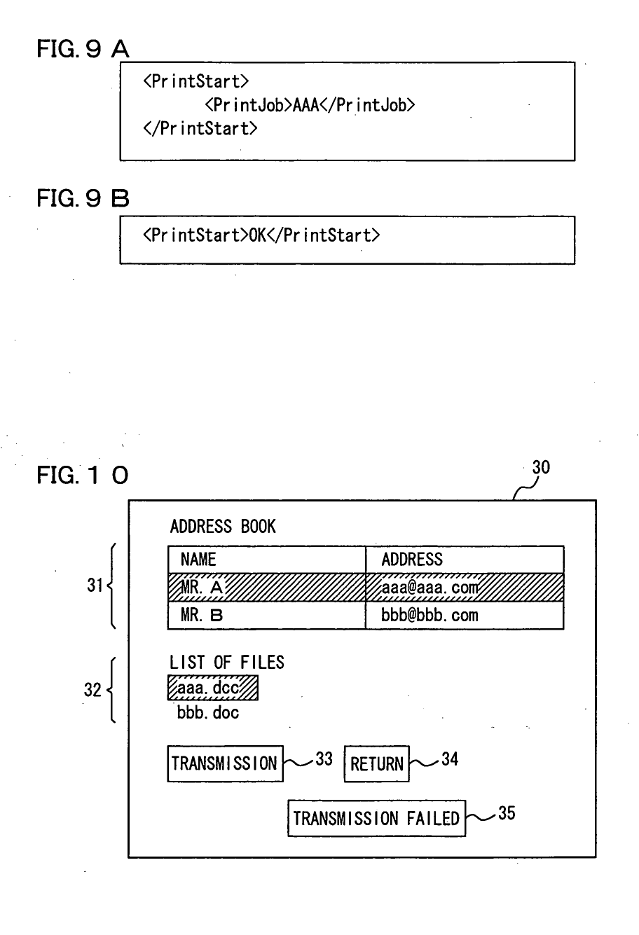

FIG. 9A is a diagram showing an example of command data generated when the instruction button in the job execution screen is instructed. Referring to FIG. 9A, in the command data, as a high-order element, an element having, as a tag, the control code “PrintStart” for instructing start of printing is described. The control code is associated with job execution screen 20 and is determined by display of job execution screen 20. The command data includes, as a low-order element, an element having, as data, the name “AAA” of the print job which specifies job data and having a tag “PrintJob” indicating that the data is job data. When the command data is analyzed by XML data analyzer 114, the control code “PrintStart” and the name “AAA” of the print job to be printed are obtained. To MFP controller 121, the control code and the name of the job are transmitted. MFP controller 121 reads a program having the same name as that of the control code and executes the program. At the time of executing the program, the name of the print job is transferred. Consequently, MFP controller 121 reads job data specified by the name “AAA” of the print job and prints data having a file name “AAA.doc” in accordance with the print job.

FIG. 9B is a diagram showing an example of response data corresponding to the command data of FIG. 9A. An example that the process is executed normally and “OK” is included as the execution result will be described here. Referring to FIG. 9B, the response data includes an element having the control code “PrintStart” shown in FIG. 9A and defined in the tag and having “OK” as data. In computer 4 for user which receives the response data, for example, as shown in FIG. 8, “Print Completed” is displayed in execution result display area 25.

FIG. 10 is a diagram showing an example of a file transmission screen displayed on the computer for user. Referring to FIG. 10, a file transmission screen 30 includes an area 31 for displaying a list of an addresses, an area 32 for displaying a list of files, a transmission button 33 in which a character train of “transmission” is displayed, a cancel button 34 in which a character train of “return” is displayed, and an execution result display area 35 for displaying an execution result.

In area 31, a list of e-mail addresses stored in MFP 1 is displayed. An e-mail address displayed includes the name of the owner of the e-mail address and the e-mail address. In area 32, a list of files stored in MFP 1 is displayed.

When the user sets a destination by selecting a desired e-mail address from the list of e-mail addresses, sets a file to be attached to an e-mail by selecting a file to be transmitted from the list of files, and instructs transmission button 33, command data is generated and transmitted to MFP 1. In the figure, an e-mail address “aaa@aaa.com” and a file “aaa.doc” being selected are hatched. Execution result display area 35 is an area for displaying a result of execution of the process by the MFP. When cancel button 34 is instructed, menu screen 10 is: displayed.

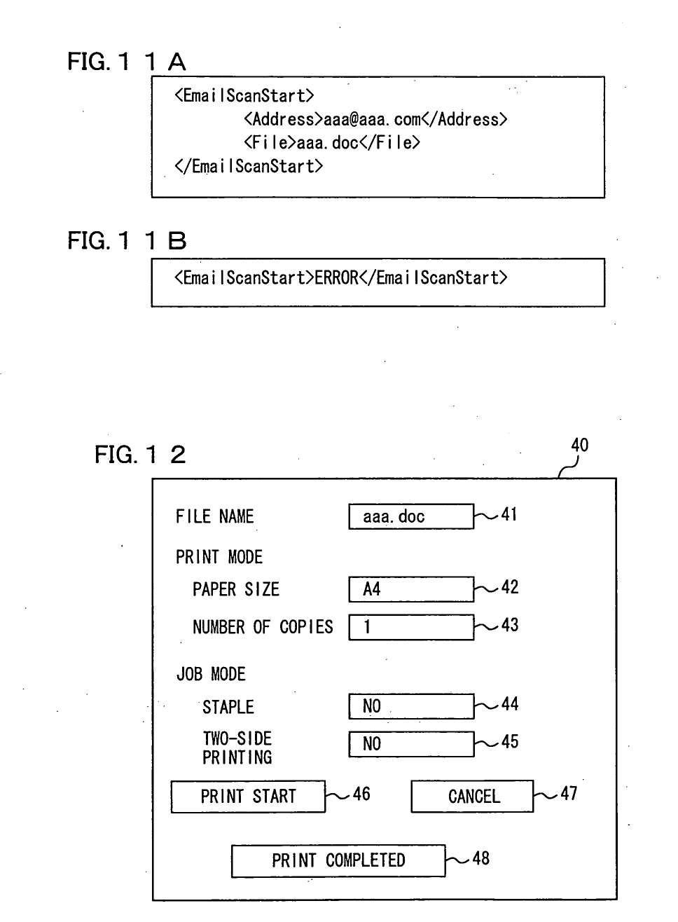

FIG. 11A is a diagram showing an example of command data generated when the transmission button is instructed in the file transmission screen. Referring to FIG. 11A, in command data, as a high-order element, an element in which a control code “EmailScanStart” for instructing transmission of an e-mail is defined in the tag is described. The control code is associated with file transmission screen 30 and is determined when file transmission screen 30 is displayed. The control code includes, as lower-order elements, an element having an e-mail address of a destination as data and having a tag “Address” indicating that the data is the destination, and an element having a file to be transmitted as data and a tag “File” indicating that the data is a file to be transmitted. When the command data is analyzed by XML data-analyzer 114, the control code “EmailScanStart”, the e-mail address “aaa@aaa.com” of the destination necessary to execute the process corresponding to the control code, and the file “aaa.doc” to be transmitted are obtained. The control code, destination address and the name of the file to be transmitted are transmitted to Web server 112. Web server 112 reads a program having the same name as that of the control code and executes the program. At the time of executing the program, the destination address and the name of the file to be transmitted are transferred. Consequently, Web server 112 reads a file specified by the file name “aaa.doc”, attaches the file to an e-mail destined to the destination address “aaa@aaa.com”, and transmits the resultant.

FIG. 11B is a diagram showing an example of response data to the command data of FIG. 11A. An example in which the process is not normally executed and “ERROR” is included as an execution result is shown. Referring to FIG. 11B, the response data includes an element having the control code “EmailScanStart” shown in FIG. 11A and defined in the tag and including “ERROR” as data. In computer 4 for user which receives the response data, for example, as shown in FIG. 10, “transmission failed” is displayed in execution result display area 35.

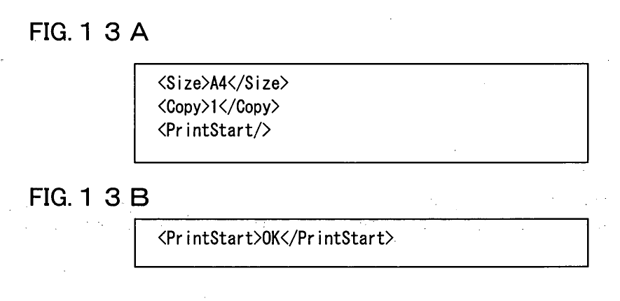

FIG. 12 is a diagram showing an example of a print execution screen displayed on the computer for user. The print execution screen is a screen displayed when a printer driver program which is pre-installed in computer 4 for user is executed. The printer driver program includes a print execution screen 40, a program for displaying print execution screen 40, a control code “PrintStart”, a program for generating command data described in the XML, having the control code defined in the tag in response to an instruction of the user, and a program for transmitting the generated command data to controller 1B. Therefore, print execution screen 40 is not included in the Web page received from MFP 1.

Referring to FIG. 12, print execution screen 40 includes an area 41 for inputting a file name, areas 42 and 43 for inputting a print mode, areas 44 and 45 for inputting a job mode, a print button 46 in which a character train of “print” is displayed, a cancel button 47 in which a character train of “return” is displayed, and an execution result display area 48 for displaying an execution result.

The area for inputting the print mode includes the area 42 for inputting a paper size, and an area 43 for inputting the number of pint copies. The area for inputting a job mode includes an area 44 for inputting whether sheets are stapled or not and an area 45 for inputting whether two-side printing is performed or not.

The diagram shows the case where “aaa.doc” is set as the file name, “A4” is set as the paper size and “1” is set as the number of print copies as the print mode, and “no” is set for stapling and “no” is set for two-side printing as the job mode. Execution result display area 48 is an area for displaying a result of execution of the process by MFP 1. When cancel button 47 is instructed, menu screen 10 is displayed.

When the user sets the file name, the print mode and the job mode and instructs the print button 46, the printer driver generates command data, transmits the command data to MFP 1, converts the file having the file name “aaa.doc” set in area 41 into print data and transmits the print data to MFP 1. The print data may be described in the AML or, for example, a printer control code.

FIG. 13A is a diagram showing an example of command data generated when the print button is instructed in the print execution screen illustrated in FIG. 12. Referring to FIG. 13A, in the command data, an element having the paper size as data and a tag in which “Size” indicating that the data is the paper size is defined, an element having the number of print copies as data and a tag in which “Copy” indicating that the data is the number of print copies is defined, and an element having, as a tag, the control code “PrintStart” for instructing printing are described. The control code is associated with print execution screen 40 and is determined when print execution screen 40 is displayed.

When the command data is analyzed by XML data analyzer 114, the paper size “A4”, the number of print copies “1” , and the control code “PrintStart” are obtained. The paper size, the number of copies, and the control code are transmitted to MFP controller 121. In MFP controller 121, a program having the same name as the control code “PrintStart” is read and executed. At the time of executing the program, the paper size “A4” and the number-of copies “1” are transmitted. Consequently, MFP controller 121 reads a file specified by the file name “aaa.doc” transmitted from the printer driver and prints the file onto a A4 sheet of paper to make one copy.

FIG. 13B is a diagram showing an example of response data corresponding to the command data of FIG. 13A. An example in which the process is normally executed and “OK” is included as an execution result is shown here. Referring to FIG. 13B, the response data includes an element having a tag in which the control code “PrintStart” shown in FIG. 13A is defined and having “OK” as data. In computer 4 for user which received the response data, for example, as shown in FIG. 12, “print completed” is displayed in execution result display area 48.

In MFP 1 in the embodiment as described above, the command data described in the XML is analyzed. For example, when the control code “PrintStart” is defined in the tag, a program corresponding to the control code “PrintStart” is read and executed. Since the control code is described in the XML, it is unnecessary to determine a special communication protocol between MFP 1 and the model of the transmission source of the control code. Since the control code is defined in the tag, the configuration of the XML is simplified and the data amount of the command data can be reduced.

Since the response data in which an element including the control code defined in the tag and having the execution result as data is described in the XML is generated, the execution result can be described in the XML by one element. Thus, the data amount of the response data can be reduced.

A Web page for inputting the control code is transmitted from MFP 1 to computer 4 for user. Since the program for generating command data in accordance with inputted data is included in the Web page, it is unnecessary to prepare a special program on the side of transmitting command data.

When the Web page transmitted from MFP 1 to computer 4 for user is executed by computer 4 for user, an input screen for inputting the control code is displayed on computer 4 for user, and command data described in the XML for executing the control is generated in accordance with data inputted to the input screen. Consequently, data described in the extensible markup language is transmitted/received between MFP 1 and the computer for user, so that it is unnecessary to determine a special communication protocol. Development and change of an application program executed by MFP 1 and computer 4 for user is facilitated.

In the embodiment, MFP 1 is described as an example of the control apparatus. Any controller controlled by computer 4 for user via network 3 can be applied in place of MFP 1.

Although the present invention has been described and illustrated in detail, it is clearly understood that the same is by way of illustration and example only and is not to be taken by way of limitation, the spirit and scope of the present invention being limited only by the terms of the appended claims.

1. A control apparatus comprising:
a receiver to receive command data described in an extensible markup language;
an analyzer to analyze said command data; and
a controller, when an element in which a control code is defined in a tag is detected from said command data by said analyzer, to execute a process which is preliminarily associated with the control code defined in the tag of said element.

2. The control apparatus according to claim 1, wherein the element in which the control code is defined in said tag is constituted only by the tag.

3. The control apparatus according to claim 1, further comprising:
a response data generator to generate response data obtained by describing, in the extensible markup language, an element having said control code defined in a tag and a result of execution of said process as data.

4. The control apparatus according to claim 3, further comprising:
a response portion to transmit the response data generated by said response data generator to an apparatus which has transmitted said command data.

5. The control apparatus according to claim 1, further comprising:
an image forming device to form an image on a recording medium.

6. The control apparatus according to claim 1, further comprising:
a Web page transmitter to transmit a Web page including an input screen for inputting a control code.

7. The control apparatus according to claim 6, wherein
said Web page includes a display portion to display said input screen.

8. The control apparatus according to claim 6, wherein
said Web page includes a command generator to generate said command data in accordance with data inputted via said input screen.

9. The control apparatus according to claim 8, wherein
said Web page includes a command transmitter to transmit said generated command data.

10. A control instruction apparatus comprising:
a display portion to display an input screen for inputting a control code;
a command data generator to generate command data described in an extensible markup language, including an element in which a control code to specify a process for executing a control is defined in a tag in accordance with data inputted via said input screen; and
a command data transmitter to transmit said generated command data.

11. The control instruction apparatus according to claim 10, wherein
said control instruction apparatus is connected to an image forming device to form an image on a recording medium.

12. The control instruction apparatus according to claim 10, wherein
the element in which the control code included in said command data is defined in said tag is constituted only by the tag.

13. The control instruction apparatus according to claim 10, further comprising:
a receiver to receive response data described in the extensible markup language, including an element having said control code defined in a tag and having a result of execution of said process as data from an apparatus which has transmitted said command data.

14. The control instruction apparatus according to claim 10, further comprising:
a Web page receiver to receive a Web page including said input screen.

15. The control instruction apparatus according to claim 14, wherein
said Web page includes a display portion to display said input screen.

16. The control instruction apparatus according to claim 14, wherein
said Web page includes said command generator.

17. A control program product to make a computer execute the steps of:
receiving command data described in an extensible markup language;
analyzing said command data; and
when an element in which a control code is defined in a tag is detected from said command data by said analyzing step, executing a process which is preliminarily associated with the control code defined in the tag of said element.

18. The control program product according to claim 17, wherein
the element in which the control code included in said command data is defined in said tag is constituted only by the tag.

19. The control program product according to claim 17, further comprising the step of:
transmitting response data described in the extensible markup language, including an element having said control code defined in the tag and having a result of execution of said process as data to an apparatus which has transmitted said command data.

20. The control program product according to claim 17, further comprising the step of:
transmitting a Web page including an input screen for inputting a control code.

21. The control program product according to claim 20, wherein
said Web page includes the step of displaying said input screen.

22. The control program product according to claim 20, wherein
said Web page includes the step of generating said command data in accordance with data inputted via said input screen.

23. The control program product according to claim 22, wherein
said Web page includes the step of transmitting said generated command data.

24. A control instruction program product to make a computer execute the steps of:
displaying an input screen for inputting a control code; and
generating command data described in an extensible markup language, including an element in which a control code to specify a process for executing a control is defined in a tag in accordance with data inputted via said input screen.

25. The control instruction program product according to claim 24, further comprising the steps of:
transmitting said generated command data to the transmission source of said control instruction program.
